(19) United States
(12) Patent Application Publication
(10) Pub. No.: US 2022/0113330 A1
(43) Pub. Date: Apr. 14, 2022

(54) AUTOMATIC ANALYZER AND CLEANING METHOD

(71) Applicant: CANON MEDICAL SYSTEMS CORPORATION, Otawara-shi (JP)

(72) Inventors: Takafumi FUJIWARA, Nasushiobara (JP); Takashi YOSHIMURA, Nasushiobara (JP); Takeshi KINPARA, Utsunomiya (JP); Shohei KAWASHIMA, Nasushiobara (JP); Tomoaki KURANO, Nasushiobara (JP); Takahiro OMORI, Otawara (JP)

(73) Assignee: CANON MEDICAL SYSTEMS CORPORATION, Otawara-shi (JP)

(21) Appl. No.: 17/450,081

(22) Filed: Oct. 6, 2021

(30) Foreign Application Priority Data
Oct. 8, 2020 (JP) 2020-170689

(51) Int. Cl. G01N 35/10; G01N 35/02

(52) U.S. Cl. CPC G01N 35/1004; G01N 2035/0441; B01L 13/02; G01N 35/025

(57) ABSTRACT

An automatic analyzer includes a cleaning pool, a discharge port, a waste fluid pipe, a valve, and a guiding unit. The cleaning pool is used to clean a predetermined member with a fluid. The discharge port discharges the fluid. The waste fluid pipe connects the cleaning pool and the discharge port. The valve is disposed to the waste fluid pipe. The guiding unit guides a cleaning fluid to the cleaning pool via the waste fluid pipe.

### CROSS REFERENCE TO RELATED APPLICATIONS

This application is based upon and claims the benefit of priority from the prior Japanese Patent Application No. 2020-170689, filed on Oct. 8, 2020, the entire contents of which are incorporated herein by reference.

### FIELD

Embodiments described herein and illustrated in the drawings relate to an automatic analyzer and a cleaning method.

### BACKGROUND

Automatic analyzers including cleaning pools for cleaning dispensing probes, used for performing qualitative or quantitative analyses of samples, are known. If a cleaning agent is left for a long time in a cleaning pool included in such an automatic analyzer, water contained in the cleaning agent may evaporate and crystals of the cleaning agent may be deposited on the inner surface of the cleaning pool. Such crystals may cause clogging of a dispensing nozzle when sucked during the cleaning of the dispensing nozzle. A technique to clean cleaning pools at regular intervals is therefore known.

In such an automatic analyzer, a waste fluid pipe, through which a fluid discharged from the cleaning pool passes, also needs to be regularly cleaned. In a prior art method, for example, the user cleans the waste fluid pipe by pouring a cleaning fluid into the waste fluid pipe via the cleaning pool, using a syringe. If this cleaning method is employed in an automatic analyzer including a plurality of cleaning pools, the user needs to pour the cleaning fluid into each of the cleaning pools so as to clean the waste fluid pipes connected to the cleaning pools. This is inconvenient for the user since it takes time to clean the waste fluid pipes. It is also possible that the waste fluid pipes may not be fully filled with the cleaning fluid, and therefore not satisfactorily cleaned.

One of the problems to be solved by the embodiments disclosed herein and the accompanying drawings is to easily clean a waste fluid pipe of an automatic analyzer. The problems to be solved by the embodiments are not limited to the above-described problem. There may be other problems such as those corresponding to the advantages of embodiments described below.

An automatic analyzer according to an embodiment includes a cleaning pool, a discharge port, a waste fluid pipe, a valve, and a guiding unit. The cleaning pool is used to clean a predetermined member with a fluid. The discharge port discharges the fluid. The waste fluid pipe connects the cleaning pool and the discharge port. The valve is disposed to the waste fluid pipe. The guiding unit guides a cleaning fluid to the cleaning pool via the waste fluid pipe.

### BRIEF DESCRIPTION OF THE DRAWINGS

FIG. 1 illustrates an example of an automatic analyzer including a cleaning system according to a first embodiment.

FIG. 2 illustrates the cleaning system according to the first embodiment.

FIG. 3 illustrates the cleaning system according to the first embodiment, when cleaning pools and waste fluid pipes are filled with a cleaning fluid.

FIG. 4 is a flowchart showing a process of cleaning the cleaning pools and the waste fluid pipes according to the first embodiment.

FIG. 5 is a diagram illustrating an example of a screen of a display included in the automatic analyzer.

FIG. 6 is a diagram illustrating an example of a screen of the display.

FIG. 7 is a diagram illustrating an automatic analyzer including a cleaning system according to a second embodiment.

FIG. 8 illustrates the cleaning system according to the second embodiment.

FIG. 9 illustrates the cleaning system according to the second embodiment, when cleaning pools and waste fluid pipes are filled with a cleaning fluid.

FIG. 10 is a flowchart showing a process of cleaning the cleaning pools and the waste fluid pipes according to the second embodiment.

FIG. 11 illustrates an example of an automatic analyzer including a cleaning system according to a third embodiment.

FIG. 12 illustrates the cleaning system according to the third embodiment.

FIG. 13 illustrates the cleaning system according to the third embodiment, when cleaning pools and waste fluid pipes are filled with a cleaning fluid.

FIG. 14 is a flowchart showing a process of cleaning the cleaning pools and the waste fluid pipes according to the third embodiment.

FIG. 15 is a diagram illustrating an example of a screen of a display.

### DETAILED DESCRIPTION

Embodiments will now be described with reference to the accompanying drawings. The scaling and the ratio between dimensions of an element may be different from those of the actual element in each drawing, for the easy understanding and the convenience of illustration.

### First Embodiment

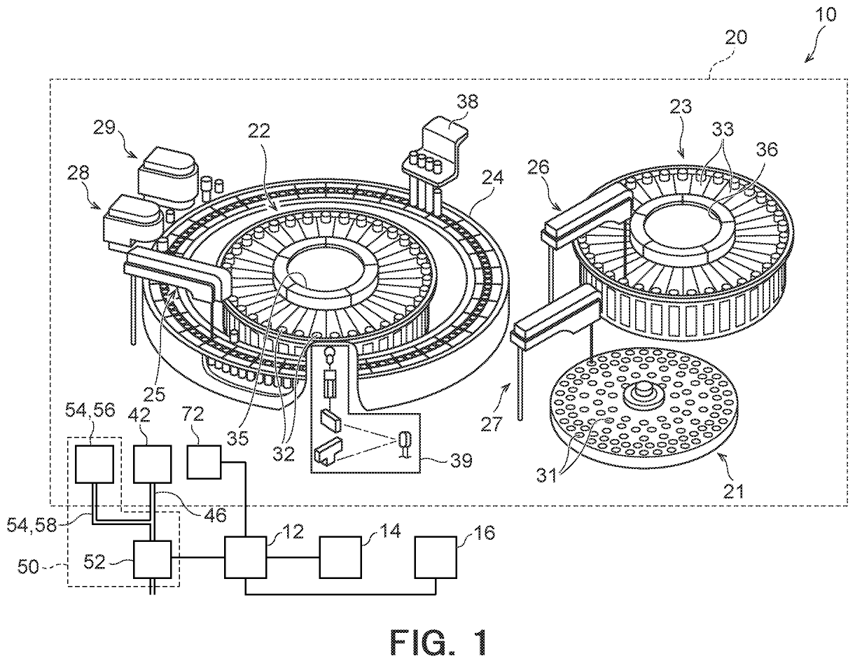

FIG. 1 illustrates an example of an automatic analyzer 10 including a cleaning system 50 according to a first embodiment. The automatic analyzer 10 includes a controller 12, a display 14, an input interface 16, and an analysis executor 20.

The analysis executor 20 generates such data as blank data, reference data, and test data. The blank data is generated through a blank measurement. The reference data is generated through a reference measurement for measuring a mixed solution containing a reference sample for each test item and a reagent used for analyzing the test item. The test data is generated through a test measurement for measuring a mixed solution containing a sample to be tested and a reagent. The analysis executor 20 includes a sample disk 21, a reagent carousel 22, a reagent carousel 23, a reaction disk 24, a first reagent dispenser 25, a second reagent dispenser 26, a sample dispenser 27, a first agitation mechanism 28, and a second agitation mechanism 29.

The sample disk 21 includes a plurality of sample containers 31, containing samples to be tested such as a reference sample and blood serum. The reagent carousel 22 includes a reagent rack 35 that stores a plurality of reagent containers 32 in a rotatable manner. The reagent rack 35 thus stores and cools first reagents contained in the reagent containers 32. Each of the first reagents stored in the reagent containers 32 is, for example, a first reagent of a one reagent system or a two reagent system, which reacts with a component of a test item included in a reference sample or a sample to be tested, for example.

The reagent carousel 23 includes a reagent rack 36 that stores a plurality of reagent containers 33 in a rotatable manner. The reagent rack 36 stores and cools second reagents stored in the reagent containers 33. Each reagent container 33 thus stores a second reagent that is used with a first reagent.

The reaction disk 24 has a plurality of fixing tools that are detachably attached on the circumference of the reaction disk 24. The fixing tools hold a plurality of reaction containers at predetermined intervals. Thus, the reaction disk 24 includes a plurality of fixing tools used for fixing a plurality of reaction containers, and holds the reaction containers in a removable manner.

The first reagent dispenser 25 includes a probe, an arm, and a cleaning pool. The probe is used for a dispensing operation including an aspiration of the first reagent in one of the reagent containers 32 stored in the reagent rack 35 and a discharge of the first reagent into a reaction container to which a sample is discharged. The arm holds the probe in a rotatable and a vertically movable manner. The cleaning pool is used for cleaning the probe every time the dispensing operation is finished for one of the first reagents.

The second reagent dispenser 26 includes a probe, an arm, and a cleaning pool. The probe is used for a dispensing operation including an aspiration of the second reagent in one of the reagent containers 33 stored in the reagent rack 36, and a discharge of the second reagent into the reaction container to which the first reagent is discharged. The arm holds the probe in a rotatable and a vertically movable manner. The cleaning pool is used for cleaning the probe every time the dispensing operation is finished for one of the second reagents.

The sample dispenser 27 includes a probe, an arm, and a cleaning pool. The probe is used for a dispensing operation including an aspiration of a sample in one of the sample containers 31 stored in the sample disk 21, and a discharge of the sample into the reaction container. The arm holds the probe in a rotatable and a vertically movable manner. The cleaning pool is used for cleaning the probe every time the dispensing operation is finished for one of the samples.

The first agitation mechanism 28 includes an agitator, an arm, and a cleaning pool. The agitator agitates a mixed solution including the sample and the first reagent that have been dispensed into the reaction container. The arm holds the agitator in a rotatable and a vertically movable manner. The cleaning pool is used for cleaning the agitator every time the agitation of the mixed solution is finished.

The second agitation mechanism 29 includes an agitator, an arm, and a cleaning pool. The agitator agitates a mixed solution including the sample, the first reagent, and the second reagent dispensed into the reaction container. The arm holds the agitator in a rotatable and a vertically movable manner. The cleaning pool is used for cleaning the agitator every time the agitation of the mixed solution is finished.

The automatic analyzer 10 also includes a reaction container cleaner 38 and a measuring unit 39. The reaction container cleaner 38 cleans the reaction container for which the measurement is finished. Specifically, the reaction container cleaner 38 cleans and dries the reaction container, and pours blank water used for a blank measurement of the next measurement.

The measuring unit 39 measures light passing through a reaction container containing a fluid such as water or a mixed solution. The reaction container cleaner 38 performs a cleaning operation in which the inside of the reaction container, for which the measuring unit 39 finishes the measurement of the mixed solution, is cleaned and dried. The reaction container cleaner 38 also pours a blank fluid such as pure water to the cleaned reaction container for a blank measurement.

The measuring unit 39 generates blank data by performing a blank measurement. Light that passes through a reaction container containing a blank fluid is measured in the blank measurement. The measuring unit 39 also generates reference data by performing a reference measurement. Light that passes through a reaction container containing a mixed solution, to which a reference sample and a reagent are dispensed, is measured in the reference measurement. The measurement unit 39 further generates test data by performing a test measurement. Light that passes through a reaction container containing a mixed solution, to which a sample to be tested and a reagent are dispensed, is measured in the test measurement.

The controller 12 controls the respective components of the analysis executor 20. For example, the controller 12 sequentially assigns test items to reaction containers that have been cleaned through a cleaning operation performed by the reaction container cleaner 38. The test items are selected for the sample to be tested and inputted. The controller 12 then causes the reaction container cleaner 38 to pour a blank fluid to a reaction container to which a test items has been assigned. The amount of the blank fluid corresponds to the sum of the amount of the sample and the amount of the reagents that are set as the analysis parameters for the test item. Subsequently, the controller 12 causes the measuring unit 39 to perform a blank measurement of the reaction container containing the blank fluid, thereby generating blank data.

In the first embodiment, the controller 12 also controls the components of a cleaning system 50, which will be described in detail later. Specifically, the controller 12 is connected to a valve 52, a pump 66, and a fluid surface detector 72 of the cleaning system 50.

The automatic analyzer 10 also includes the display 14 and the input interface 16. The display 14 includes a monitor such as a cathode ray tube (CRT) or a liquid crystal panel, and displays and outputs such data as calibration data and analysis data. The display also displays an analysis parameter setting, a test item setting, and various types of information used in a cleaning operation performed to clean cleaning pools 42 and waste fluid pipes 46, which will be described later.

The input interface 16 is used by the user to input an instruction or information, and includes an input device such as a keyboard, a mouse device, buttons, or a touch panel. As a result of the input, the amount of a sample, the amount of the first reagent of a one reagent system, or the amount of the first and second reagent of a two reagent system may be set as an analysis parameter of each test item. Furthermore, information of the sample to be tested, and a test item determined based on the information may be inputted. The input interface 16 is also configured to be able to input various instructions relating to the process of cleaning the cleaning pools 42 and the waste fluid pipes 46, which will be described later.

The automatic analyzer 10 may include a driver for driving the respective components of the analysis executor 20. The driver may separately drive, for example, the sample disk 21, the reagent rack 35, and the reagent rack 36 to move the sample containers 31, the reagent containers 32, and the reagent containers 33. The driver may also rotatably drive the reaction disk 24 to move the reaction containers. The driver may further separately drive the aforementioned arms vertically and rotatably to move the probes connected to the arms.

The automatic analyzer 10 may also include a data processor to determine whether a reaction container may be used for a test item based on the blank data generated by the measuring unit 39. In this case, collection of blank data is performed several times, and whether the reaction container may be used for a test may be determined based on the result of the collected blank data.

If the data processor determines that the reaction container may be usable, the controller 12 causes the sample and the reagent for the test item assigned to the reaction container to be dispensed to the reaction container. On the other hand, if the data processor determines that the reaction container is not usable, the controller 12 stops the dispensing of the sample and the reagent for the test item assigned to the reaction container. In this case, the test item is assigned to a reaction container that is cleaned next to the reaction container determined by the data processor to be unusable.

The data processor may include a calculator and a data memory. The calculator processes the reference data and the test data generated by the measuring unit 39 included in the analysis executor 20 to generate such data as calibration data and analysis data of the test item. The data memory stores the collected reference data and test data, and the calibration data and the analysis data generated by the calculator.

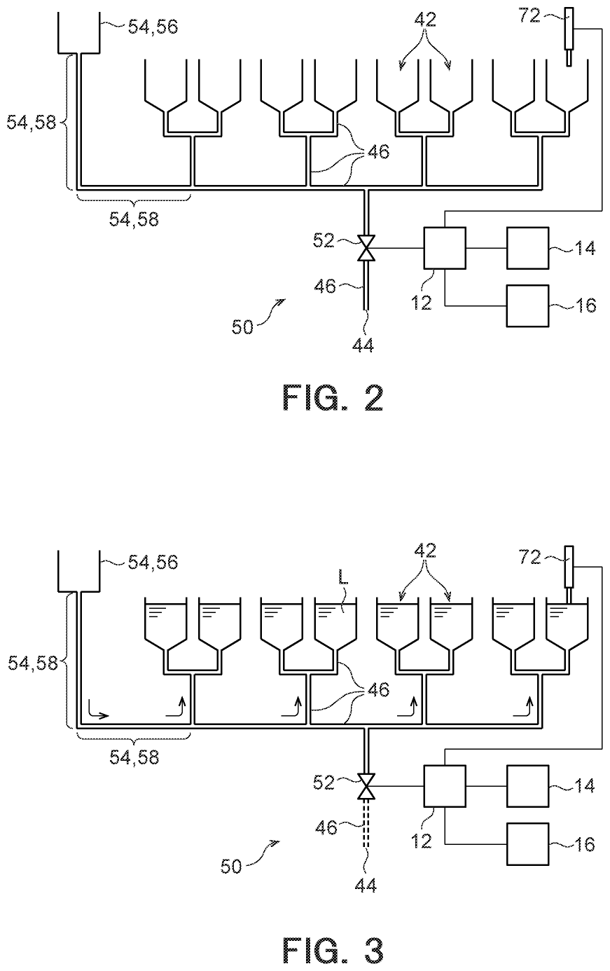

The cleaning system 50 according to the first embodiment will be described below with reference to FIGS. 2 and 3. FIG. 2 illustrates the cleaning system 50, and FIG. 3 illustrates the cleaning system 50 when the cleaning pools 42 and the waste fluid pipe 46 are filled with a cleaning fluid L.

The automatic analyzer 10 includes a plurality of cleaning pools 42. Each of the cleaning pools 42 is a container, the top of which is open, for example. In a cleaning operation, a predetermined member is put into the cleaning pool 42 from the upper side, immersed into a fluid such as water or a cleaning fluid stored in the cleaning pool 42, and cleaned. The cleaning pool 42 may be any of the cleaning pool of the first reagent dispenser 25, the cleaning pool of the second reagent dispenser 26, the cleaning pool of the sample dispenser 27, the cleaning pool of the first agitation mechanism 28, and the cleaning pool of the second agitation mechanism 29.

A waste fluid pipe 46 is connected to each cleaning pool 42. In the illustrated example, the waste fluid pipe 46 is connected to the bottom of the cleaning pool 42. A discharge port 44 is disposed at an end of the waste fluid pipe 46 opposite to the side where the cleaning pool 42 is connected. Thus, the waste fluid pipe 46 connects the cleaning pool 42 and the discharge port 44. The fluid stored in the cleaning pool 42 and used for cleaning the predetermined member is discharged into a waste fluid tank (not shown) included in the automatic analyzer 10, or discharged outside the automatic analyzer 10 via the waste fluid pipe 46.

In the first embodiment, a plurality of waste fluid pipes 46 connected to the cleaning pools 42 are connected together to communicate with a single discharge port 44. Although eight cleaning pools 42 are illustrated in FIGS. 2 and 3, the number of cleaning pools 42 is not limited to eight. In the illustrated example, each waste fluid pipe 46 is connected to one of the cleaning pools 42, two each of eight waste fluid pipes 46 are connected together to form four waste fluid pipes 46, and the four waste fluid pipes 46 are further connected together to form a single waste fluid pipe 46.

The cleaning system 50 is used for cleaning the inside of each of the cleaning pools 42 and the waste fluid pipes 46. The cleaning system 50 includes a valve 52 disposed to the waste fluid pipe 46, and a guiding unit 54 for guiding a cleaning fluid L to the cleaning pools 42 via the waste fluid pipes 46.

The valve 52 is disposed at a middle portion of the waste fluid pipes 46. In particular, the valve 52 is disposed between a portion where the waste fluid pipes 46 are connected to form a single pipe and the discharge port 44. In this case, the flow path between the discharge port 44 and all of the cleaning pools 42 and the waste fluid pipes 46 connected to the single valve 52 may be opened or closed by opening or closing the valve 52. The valve 52 may be, for example, an electromagnetic valve. If the valve 52 is an electromagnetic valve, the valve 52 may be opened or closed by the controller 12. In the first embodiment, the valve 52 is a two-way valve.

The guiding unit 54 guides a cleaning fluid L to the cleaning pools 42 through the waste fluid pipes 46. The cleaning fluid L may be used for cleaning the insides of the cleaning pools 42 and the waste fluid pipes 46. The guiding unit 54 guides the cleaning fluid L to the waste fluid pipes 46 from a portion that is different from the portions connected to the cleaning pools 42. In the first embodiment, the guiding unit 54 includes an inlet 56 from which the cleaning fluid L is poured, and a connection pipe 58 connecting the inlet 56 and the waste fluid pipes 46. The connection pipe 58 is connected to a portion of the waste fluid pipes 46 between the cleaning pools 42 and the valve 52. Thus, connection pipe 58 connects the inlet 56 and the portion of the waste fluid pipes 46 between the cleaning pools 42 and the valve 52.

In the first embodiment, the upper end of the inlet 56 is located above the upper ends of the cleaning pools 42. This may prevent the cleaning fluid L in the inlet 56 from overflowing the upper end of the inlet 56. However, the upper end of the inlet 56 may be located at the same height as the upper ends of the cleaning pools 42 or lower than the upper ends of the cleaning pools 42.

The fluid surface detector 72 is disposed to the cleaning pools 42. The fluid surface detector 72 detects the fluid surface of the fluid stored in the cleaning pools 42. The fluid surface detector 72 may be a detector including a probe, for example, and detects the location of the fluid surface where the probe contacts. Information on the location of the fluid surface detected by the fluid surface detector 72 is sent to the controller 12. The fluid surface detector 72 may be a dedicated detector detecting the fluid surface. A reagent probe or a sample probe having a fluid surface detecting function may be used as the fluid surface detector 72. In other words, a reagent probe or a sample probe having a fluid surface detecting function may act as the fluid surface detector 72.

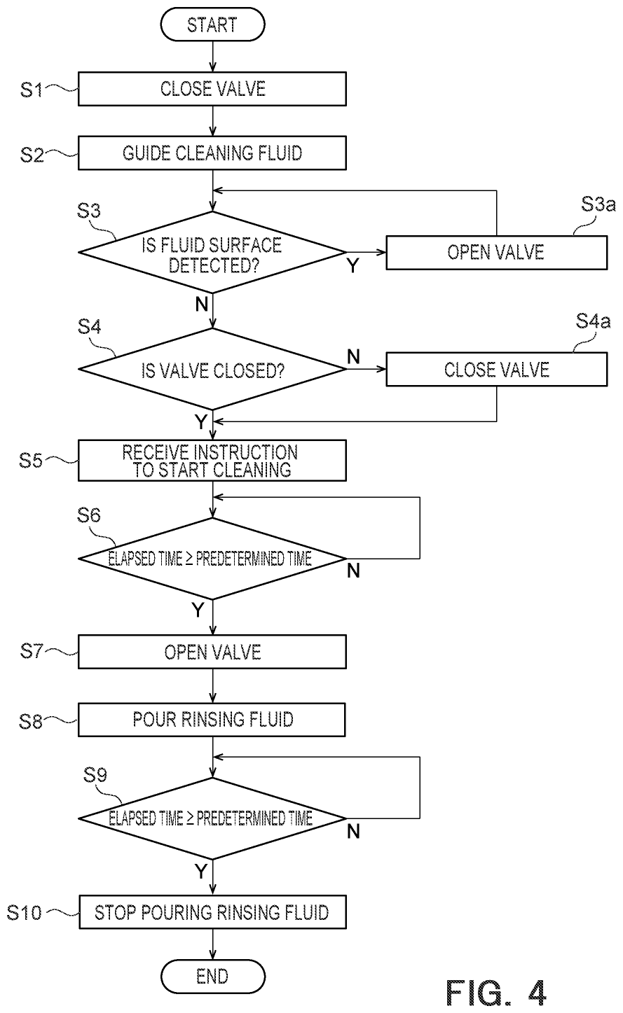

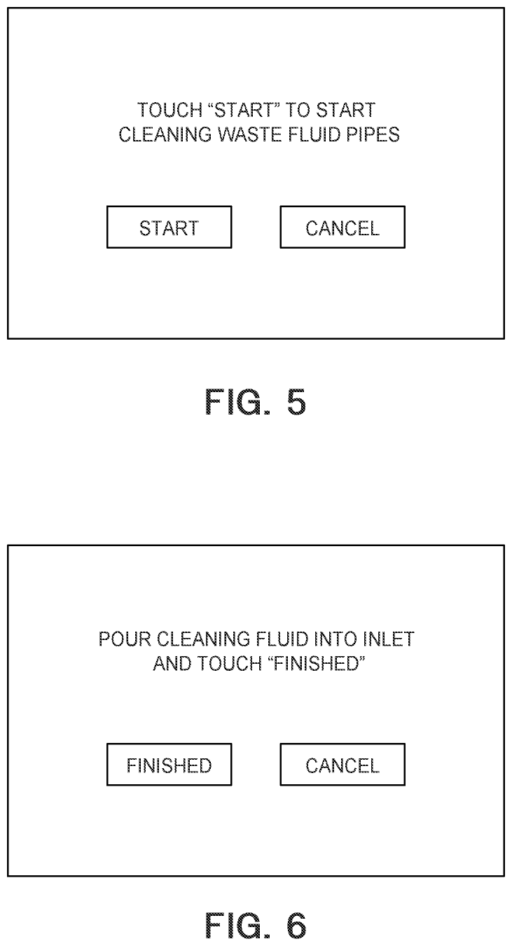

A cleaning method according to the first embodiment will be described with reference to FIGS. 4 to 6. FIG. 4 is a flowchart showing a process of cleaning the cleaning pools 42 and the waste fluid pipes 46 according to the first embodiment, and each of FIGS. 5 and 6 shows an example of a screen of the display 14.

First, the screen shown in FIG. 5 appears on the display 14, and the process waits for an input to the input interface 16 by the user. In the first embodiment, the input interface 16 is a touch panel disposed to overlap the screen of the display 14. If the user touches “START” shown on the screen illustrated in FIG. 5, a signal commanding the start of the cleaning of the cleaning pools 42 and the waste fluid pipes 46 is sent from the input interface 16 to the controller 12. The screen shown in FIG. 6 then appears on the display 14 to instruct the user to pour the cleaning fluid L into the inlet 56.

### Closing Step S1

When the valve 52 is open, and the fluid in the cleaning pools 42 and the waste fluid pipes 46 has all been discharged, a closing step S1 is performed to close the valve 52 thereby to close the flow path between the cleaning pools 42 and the discharge port 44. If the valve 52 is an electromagnetic valve, the valve 52 is closed by means of a signal from the controller 12.

### Guiding (Cleaning Fluid Pouring) Step S2

A guiding step S2 is then performed, in which the user pours the cleaning fluid L into the inlet 56, and the poured cleaning fluid L is guided to the cleaning pools 42 via the waste fluid pipes 46. The cleaning fluid L poured into the inlet 56 is guided to the cleaning pools 42 and the waste fluid pipes 46 via the connection pipe 58 (see FIG. 3). In the first embodiment, the cleaning fluid L is poured until the fluid surface of the cleaning fluid L reaches a predetermined height in the cleaning pools 42. As a result, both the insides of the waste fluid pipes 46 and the insides of the cleaning pools 42 may be cleaned. It is preferable that the cleaning fluid L be measured in advance to set the amount by which the fluid surface of the cleaning fluid L reaches the predetermined height. This enables the user to pour an appropriate amount of the cleaning fluid L into the inlet 56 from the upper ends of the cleaning pools 42, without causing the overflow of the cleaning fluid L, even if the cleaning pools 42 are not provided with the fluid surface detector 72. The appropriate amount means an amount to fill the cleaning pools 42 and the waste fluid pipes 46 with the cleaning fluid L.

### Fluid Surface Detecting Step S3

If the cleaning pools 42 are provided with the fluid surface detector 72, a fluid surface detecting step S3 is performed for detecting the location of the fluid surface in the cleaning pools 42. The location of the fluid surface of the cleaning fluid L may be set at a predetermined height where the overflow of the cleaning fluid L from the upper ends of the cleaning pools 42 does not occur. If the height of the inlet 56 is lower than the height of the cleaning pools 42, the predetermined height of the cleaning fluid L is preferably set at a height where the overflow of the cleaning fluid L from the inlet 56 does not occur. When detecting that the fluid surface of the cleaning fluid L reaches the predetermined height, the fluid surface detector 72 sends a detection signal to the controller 12. If the cleaning fluid L is kept being poured into the inlet 56 after the fluid surface detector 72 detects that the fluid surface of the cleaning fluid L reaches the predetermined height, an overflow of the cleaning fluid L from the upper ends of the cleaning pools 42 may occur. In order to avoid this, the controller 12 perform a valve opening step S3a for opening the valve 52 upon receiving the detection signal from the fluid surface detector 72. As a result, the cleaning fluid L in the cleaning pools 42 and the waste fluid pipes 46 is discharged from the discharge port 44 via the valve 52, and the fluid surface of the cleaning fluid L is lowered.

### Valve Closing Checking Step S4

Until the fluid surface detector 72 does not detect that the fluid surface of the cleaning fluid L reaches the predetermined height, and when the fluid surface detector 72 once detects that the fluid surface of the cleaning fluid L reaches the predetermined height and then does not detect that, a valve closing checking step S4 is performed for checking whether the valve 52 is closed. In the valve closing checking step S4, the controller 12 checks a signal received from the valve 52. If it is determined in the valve closing checking step S4 that the valve 52 is not closed (the valve 52 is open), a valve closing step S4a is performed to close the valve 52. If it is determined that the valve 52 is closed in the valve closing checking step S4, the valve closing step S4a is not performed.

### Input Receiving Step S5

The display 14 performs an input receiving step S5 to receive an input indicating that the pouring of the cleaning fluid L into the inlet 56 is finished, while keeping the display of the screen illustrated in FIG. 6. After pouring the cleaning fluid L into the inlet 56, the user touches the “FINISHED” button shown in FIG. 6. As a result, a signal indicating that the cleaning fluid L has been poured into the inlet 56 is sent from the input interface 16 to the controller 12. The controller 12 counts the time elapsed from the reception of the signal indicating that the cleaning fluid L has been poured into the inlet 56.

### Elapsed Time Measuring Step S6

The controller 12 then performs an elapsed time measuring step S6 for determining whether the elapsed time is equal to or longer than a predetermined period of time. If it is determined that the elapsed time is shorter than the predetermined period of time, the controller 12 repeatedly performs the elapsed time measuring step S6 at predetermined intervals (for example, one second). If it is determined that the elapsed time is equal to or longer than the predetermined period of time, a discharging step S7 is performed. The predetermined period of time mentioned above is set so that the insides of the cleaning pools 42 and the waste fluid pipes 46 are sufficiently cleaned with the cleaning fluid L. The predetermined period of time mentioned above may be a period of time stored in the controller 12 in advance, or a period of time inputted by the user on the screen shown in FIG. 5 or FIG. 6.

### Discharging Step S7

In the discharging step S7, the valve 52 is opened to discharge the cleaning fluid L from the cleaning pools 42 and the waste fluid pipes 46. As a result, the cleaning fluid L that has cleaned the insides of the cleaning pools 42 and the waste fluid pipes 46 flows through the waste fluid pipes 46 and is discharged from the discharge port 44.

### Rinsing Fluid Guiding Step S8

A rinsing fluid guiding step S8 is then performed to rinse out the cleaning fluid L remaining in the cleaning pools 42 and the waste fluid pipes 46. The rinsing fluid may be water, for example. The rinsing fluid guiding step S8 is performed by pouring the rinsing fluid into the cleaning pools 42 and the waste fluid pipes 46 from the cleaning pools 42, for example. In the first embodiment, the cleaning pools 42 and the waste fluid pipes 46 are rinsed with the rinsing fluid is kept flowing into the cleaning pools 42 and the waste fluid pipe 46.

### Elapsed Time Measuring Step S9

The controller 12 then performs an elapsed time measuring step S9 for determining whether the elapsed time is equal to or longer than a predetermined period of time. The elapsed time measuring step S9 is performed in the same manner as the elapsed time measuring step S6 described above.

### Rinsing Fluid Stopping Step S10

If it is determined that the elapsed time is equal to or longer than a predetermined period of time, a rinsing fluid stopping step S10 is performed and the pouring of the rinsing fluid is stopped. As a result, the cleaning of the cleaning pools 42 and the waste fluid pipes 46 is completed.

When the cleaning pools 42 and the waste fluid pipes 46 are rinsed, a stored-water rinsing step may be performed, in which the valve 52 is closed to store the rinsing fluid in the cleaning pools 42 and the waste fluid pipes 46, and after a predetermined period of time passes, the valve 52 is opened to discharge the rinsing fluid from the cleaning pools 42 and the waste fluid pipes 46. The stored-water rinsing step may be repeated a plurality of times.

The above-described embodiment may be modified in several manners. Other embodiments will be described below with reference to the drawings. In the following descriptions and the drawings used for supporting the descriptions, elements having substantially the same structures and functions have the same numerical symbols, and the explanations of such elements are not repeated.

### Second Embodiment

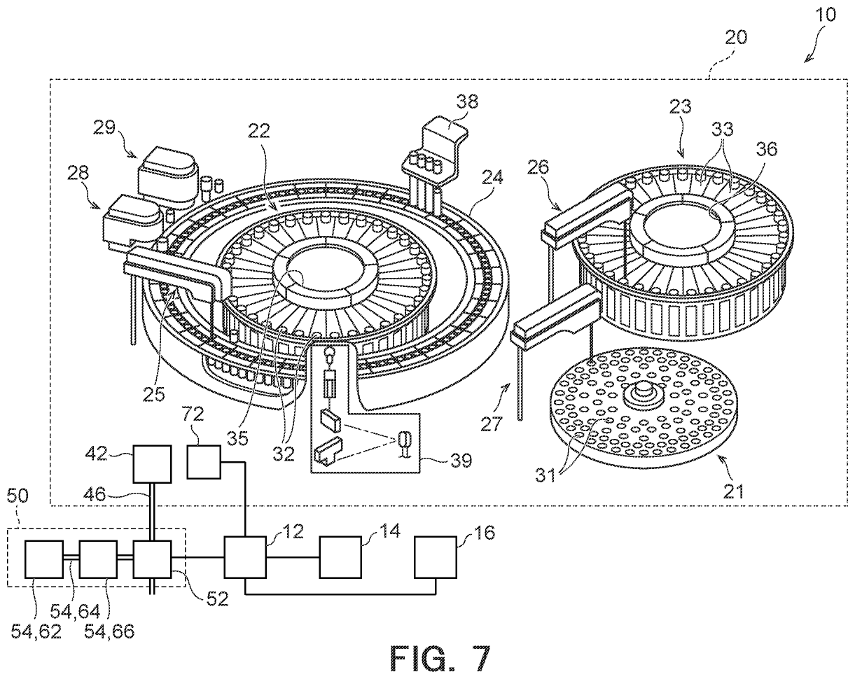

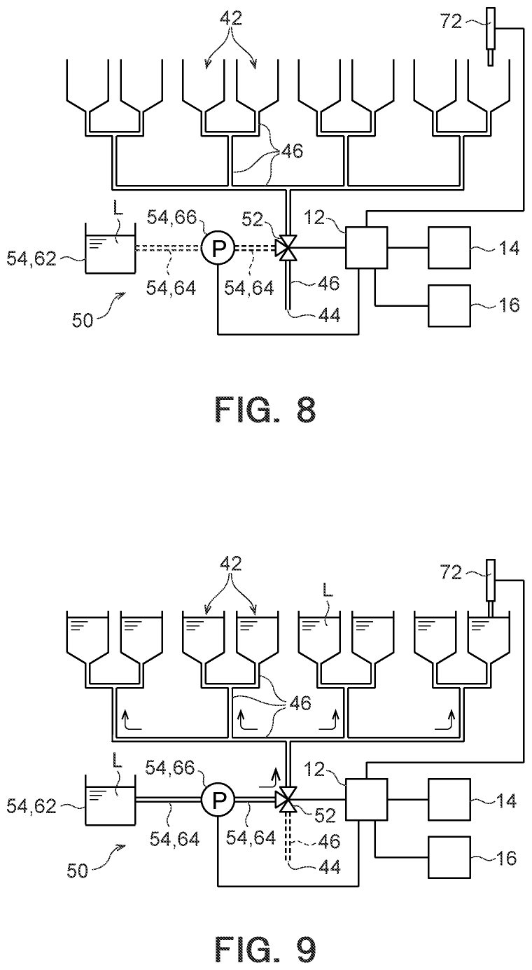

FIG. 7 illustrates an example of an automatic analyzer 10 including a cleaning system 50 according to a second embodiment. FIG. 8 illustrates the cleaning system 50. FIG. 9 illustrates the cleaning system 50 when cleaning pools 42 and waste fluid pipe 46 are filled with a cleaning fluid L.

The cleaning system 50 includes a valve 52 disposed to the waste fluid pipe 46, and a guiding unit 54 for guiding a cleaning fluid L to the cleaning pools 42 via the waste fluid pipes 46. In the second embodiment, the guiding unit 54 includes a tank 62 and a connection pipe 64. The tank 62 is a container for storing the cleaning fluid L, and included in the automatic analyzer 10. The tank 62 preferably has a cleaning fluid L capacity sufficient for cleaning the cleaning pools 42 and the waste fluid pipes 46 several times. The connection pipe 64 connects the tank 62 and the valve 52. In the second embodiment, the valve 52 is a three-way valve, which may switch the state between a first state in which a flow path between the cleaning pools 42 and the discharge port 44 is opened and a flow path between the cleaning pools 42 and the connection pipe 64 is closed, and a second state in which the flow path between the cleaning pools 42 and the connection pipe 64 is opened and the flow path between the cleaning pools 42 and the discharge port 44 is closed. The guiding unit 54 according to the second embodiment also includes a pump 66 disposed to the connection pipe 64. The pump 66 is controlled by the controller 12, and sends the cleaning fluid L stored in the tank 62 to the valve 52.

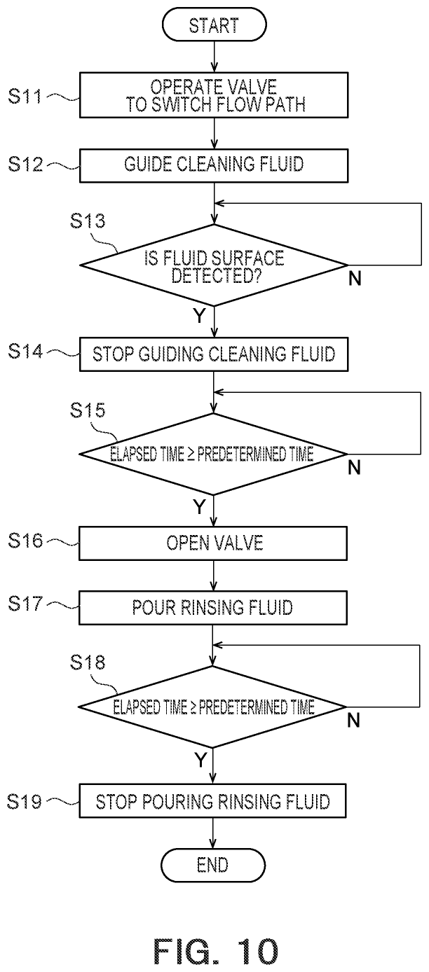

A cleaning method according to the second embodiment will now be described. FIG. 10 is a flowchart showing the process of cleaning the cleaning pools 42 and the waste fluid pipes 46 according to the second embodiment.

First, the screen shown in FIG. 5 appears on the display 14, and the process waits for an input to the input interface 16 by the user. If the user touches “START” shown on the screen illustrated in FIG. 5, a signal commanding the start of the cleaning of the cleaning pools 42 and the waste fluid pipes 46 is sent from the input interface 16 to the controller 12.

### Flow Path Switching Step S11

A flow path switching step S11 is then performed, in which the valve 52 is controlled to open the flow path between the cleaning pools 42 and the connection pipe 64 and to close the flow path between the cleaning pools 42 and the discharge port 44. The flow path switching step S11 may be called “closing step” for closing the flow path between the cleaning pools 42 and the discharge port 44.

### Guiding Step S12

A guiding step S12 is then performed, in which the cleaning fluid L stored in the tank 62 is guided to the cleaning pools 42 via the waste fluid pipes 46. In the guiding step S12, the pump 66 starts operating upon receiving a signal from the controller 12. As a result, the cleaning fluid L stored in the tank 62 flows toward the cleaning pools 42 and the waste fluid pipes 46 (see FIG. 9). In the second embodiment, the cleaning fluid L is sent until the fluid surface of the cleaning fluid L in the cleaning pools 42 reaches a predetermined height. Therefore, not only the insides of the waste fluid pipes 46 but also the insides of the cleaning pools 42 may be cleaned.

### Fluid Surface Detecting Step S13

A fluid surface detecting step S13 is then performed to detect the location of the fluid surface in the cleaning pools 42. A predetermined height of the fluid surface of the cleaning fluid L may be set so that the cleaning fluid L does not overflow from the upper ends of the cleaning pools 42. If a fluid surface detector 72 detects that the fluid surface of the cleaning fluid L reaches a predetermined height, a detection signal is sent from the fluid surface detector 72 to the controller 12.

### Guiding Stopping Step S14

Upon receiving the detection signal from the fluid surface detector 72, the controller 12 performs a guiding stopping step S14 for stopping the operation of the pump 66.

### Elapsed Time Measuring Step S15 to Rinsing Fluid Stopping Step S19

After the operation of the pump 66 is stopped, an elapsed time measuring step S15, a discharging step S16, a rinsing fluid guiding step S17, an elapsed time measuring step S18, and a rinsing fluid stopping step S19 are sequentially performed. Those steps are the same as the elapsed time measuring step S6, the discharging step S7, the rinsing fluid guiding step S8, the elapsed time measuring step S9, and the rinsing fluid stopping step S10 of the first embodiment. Therefore, those steps are not described in detail.

A notice may be sent to the user if the amount of the cleaning fluid L remaining in the tank 62 becomes less than a predetermined amount in the guiding step S12. For example, a notice may be displayed on the display 14 to the effect that the remaining amount of the cleaning fluid L in the tank 62 becomes less than the predetermined amount. The remaining amount of the cleaning fluid L in the tank 62 may be measured by a fluid surface detector or a weighing device. The notice may be provided when, for example, the remaining amount of the cleaning fluid L in the tank 62 becomes less than an amount sufficient for cleaning the cleaning pools 42 and the waste fluid pipes 46 one time.

### Third Embodiment

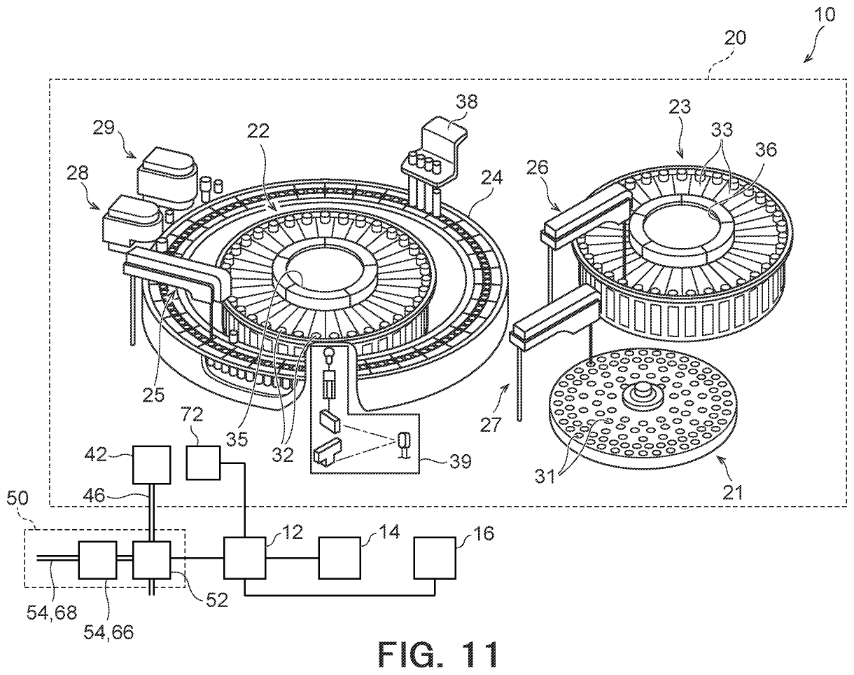

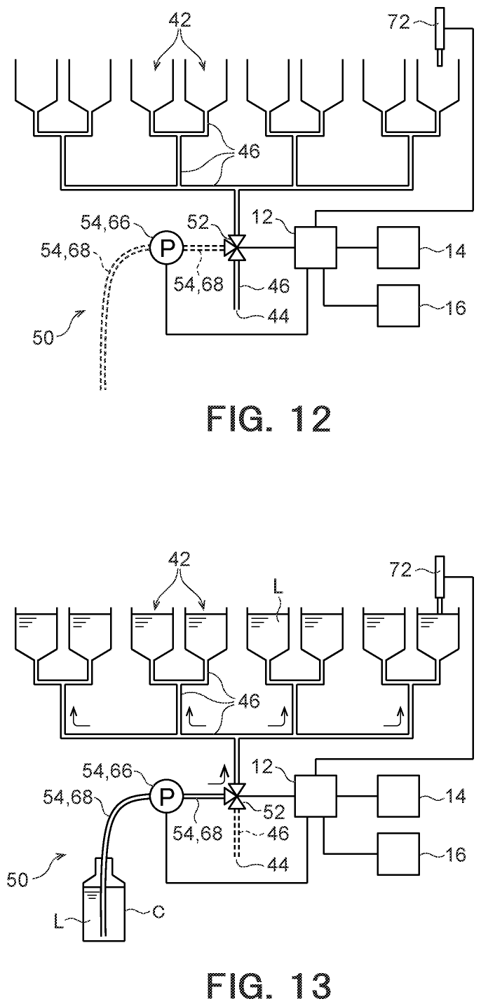

FIG. 11 illustrates an example of an automatic analyzer 10 including a cleaning system 50 according to a third embodiment. FIG. 12 illustrates the cleaning system 50. FIG. 13 illustrates the cleaning system 50 when cleaning pools 42 and waste fluid pipe 46 are filled with a cleaning fluid L.

The cleaning system 50 includes a valve 52 disposed in the waste fluid pipe 46, and a guiding unit 54 for guiding a cleaning fluid L to the cleaning pools 42 via the waste fluid pipes 46. In the third embodiment, the guiding unit 54 includes a connection pipe 68 that may connect an external container C, which contains the cleaning fluid L, and the valve 52. In the third embodiment, the valve 52 is a three-way valve, which may switch the state between a first state in which a flow path between the cleaning pools 42 and the discharge port 44 is opened and a flow path between the cleaning pools 42 and the connection pipe 68 is closed, and a second state in which a flow path between the cleaning pools 42 and the connection pipe 68 is opened and a flow path between the cleaning pools 42 and the discharge port 44 is closed.

The external container C containing the cleaning fluid L is movable, and intended to be connected to the connection pipe 68 when the cleaning pools 42 and the waste fluid pipes 46 are cleaned, and be removed from the connection pipe 68 after the cleaning pools 42 and the waste fluid pipes 46 are cleaned. The amount of the cleaning fluid L stored in the external container C may be an amount sufficient to clean the cleaning pools 42 and the waste fluid pipes 46 once, or a plurality of times. If the amount of the cleaning fluid L stored in the external container C is sufficient for performing the cleaning only once, the cleaning pools 42 and the waste fluid pipes 46 may be filled with the cleaning fluid L, without causing an overflow of the cleaning fluid L from the upper ends of the cleaning pools 42, even if all the amount of the cleaning fluid L in the external container C is sent to the cleaning pools 42 and the waste fluid pipes 46. Thus, it is not necessary to provide a fluid surface detector 72 to the cleaning pools 42.

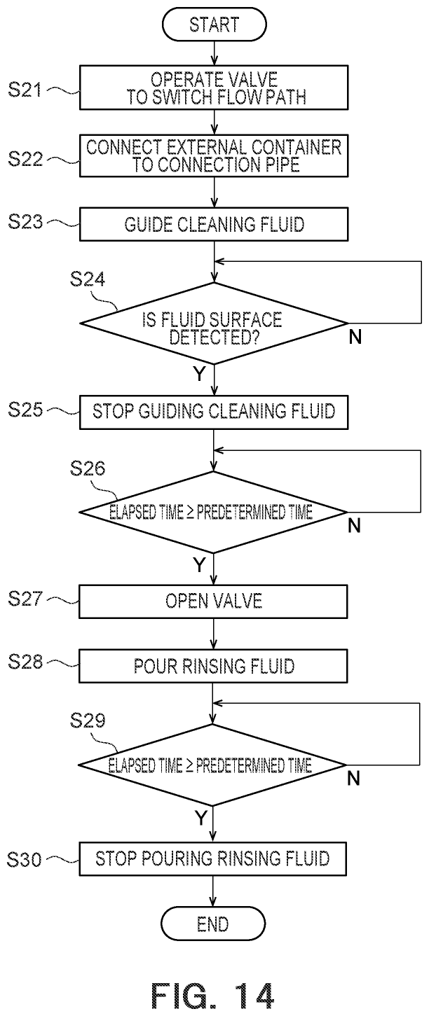

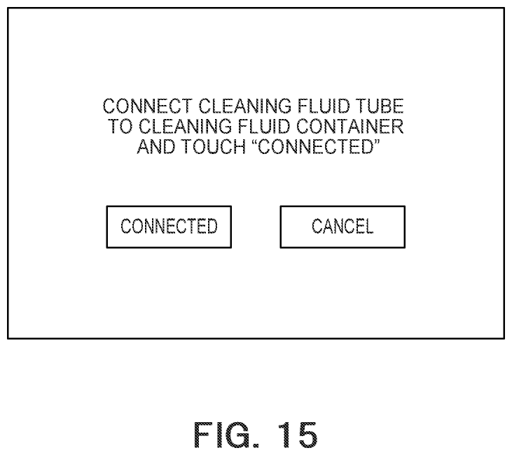

A cleaning method according to the third embodiment will now be described. FIG. 14 is a flowchart showing the process of cleaning the cleaning pools 42 and the waste fluid pipes 46 according to the third embodiment. FIG. 15 shows an example of a screen of the display 14.

First, the screen shown in FIG. 5 appears on the display 14, and the process waits for an input to an input interface 16 by the user. If the user touches “START” shown on the screen illustrated in FIG. 5, a signal commanding the start of the cleaning of the cleaning pools 42 and the waste fluid pipes 46 is sent from the input interface 16 to the controller 12. The screen shown in FIG. 15 then appears on the display 14 to instruct the user to connect the external container C storing the cleaning fluid L to the connection pipe 68.

### Flow Path Switching Step S21

A flow path switching (closing) step S21 is then performed in the same manner as the flow path switching step S11 according to the second embodiment.

### External Container Connecting Step S22

An external container connecting step S22 is then performed, in which the external container C storing the cleaning fluid L is connected to the connection pipe 68. The external container connecting step S22 may be performed, for example, by the user inserting the connection pipe 68 into the external container C, so that an end of the connection pipe 68 opposite to the valve 52 is immersed in the cleaning fluid L. When the external container C has been connected, the user touches a “connected” button on the screen shown in FIG. 15. As a result, a signal notifying that the external container C has been connected is sent from the input interface 16 to the controller 12.

### Guiding Step S23

A guiding step S23 is then performed, in which the cleaning fluid L stored in the external container C is guided to the cleaning pools 42 and the waste fluid pipes 46. In the guiding step S23, the pump 66 starts operating upon receiving a signal from the controller 12. As a result, the cleaning fluid L stored in the external container C flows toward the cleaning pools 42 and the waste fluid pipes 46 (FIG. 13). In the third embodiment, the cleaning fluid L is sent until the fluid surface of the cleaning fluid L in the cleaning pools 42 reaches a predetermined height. Therefore, not only the insides of the waste fluid pipes 46 but also the insides of the cleaning pools 42 may be cleaned.

### Fluid Surface Detecting Step S24 to Rinsing Fluid Stopping Step S30

After the guiding step S23, a fluid surface detecting step S24, a guiding stopping step S25, an elapsed time measuring step S26, a discharging step S27, a rinsing fluid guiding step S28, an elapsed time measuring step S29, and a rinsing fluid stopping step S30 are sequentially performed. Those steps are the same as the fluid surface detecting step S13, the guiding stopping step S14, the elapsed time measuring step S15, the discharging step S16, the rinsing fluid guiding step S17, the elapsed time measuring step S18, and the rinsing fluid stopping step S19 of the second embodiment. Therefore, those steps are not described in detail.

A notice may be sent to the user if the fluid surface of the cleaning fluid L is not detected within a predetermined period of time in the fluid surface detecting step S24. For example, a notice to the effect that the time is over may be displayed on the display 14. The reason why the fluid surface of the cleaning fluid L is not detected within a predetermined period of time may be the shortage of cleaning fluid L in the external container C.

If the amount of the cleaning fluid L stored in the external container C is only sufficient to perform the cleaning one time, the fluid surface detector 72 may be omitted. Furthermore, the fluid surface detecting step S24 and the guiding stopping step S25 may be omitted so that when the guiding step S23 is finished, the elapsed time measuring step S26 is started to count the elapsed time.

The automatic analyzer 10 according to any of the above-described embodiments includes the valve 52 disposed in the waste fluid pipe 46. The valve 52 enables the switching of the state between the first state in which the cleaning pools 42 communicate with the discharge port 44 and the second state in which the cleaning pools 42 do not communicate with the discharge port 44. When the valve 52 is controlled to close the flow path between the cleaning pools 42 and the discharge port 44, the cleaning fluid L may be stored in the cleaning pools 42 and the waste fluid pipes 46 for a predetermined period of time. This enables a fluid-filled cleaning of the cleaning pools 42 and the waste fluid pipes 46 using the cleaning fluid L. When the valve 52 is controlled to open the flow path between the cleaning pools 42 and the discharge port 44, the cleaning fluid L in the cleaning pools 42 and the waste fluid pipes 46 may be discharged through the discharge port 44. Therefore, it is not necessary for the user to pour a cleaning fluid into each of the cleaning pools and the waste fluid pipe connected to each of the cleaning pools, as in the prior art methods. Thus, it is possible to easily clean the cleaning pools 42 and the waste fluid pipes 46.

The valve 52 of the first embodiment may be a three-way valve like the second embodiment and the third embodiment, and the connection pipe 58 of the first embodiment may be connected to the valve 52. In other words, the guiding unit 54 may include an inlet 56 from which the cleaning fluid L is poured and a connection pipe 58 connecting the inlet 56 and the valve 52. In this case, the connection pipe 58 may have a pump 66 for sending the cleaning fluid L to the valve 52.

While some embodiments and modifications have been described, those embodiments and modifications have been presented by way of example only, and are not intended to limit the scope of the inventions. The embodiments and modifications may be performed in a variety of other forms. Furthermore, various omissions, substitutions, changes, and combinations of the embodiments and the modifications may be made without departing from the spirit of the inventions. The accompanying claims and their equivalents are intended to cover such embodiments and modifications as would fall within the scope and spirit of the inventions.

1. An automatic analyzer comprising:
a cleaning pool in which a predetermined member is cleaned with a fluid;
a discharge port from which the fluid is discharged;
a waste fluid pipe configured to connect the cleaning pool and the discharge port;
a valve disposed to the waste fluid pipe; and
a guiding unit configured to guide a cleaning fluid to the cleaning pool via the waste fluid pipe.

2. The automatic analyzer according to claim 1, wherein the guiding unit includes an inlet through which the cleaning fluid is poured, and a connection pipe configured to connect the inlet and the waste fluid pipe.

3. The automatic analyzer according to claim 2, wherein an upper end of the inlet is located above an upper end of the cleaning pool.

4. The automatic analyzer according to claim 1, wherein the guiding unit includes an inlet through which the cleaning fluid is poured, and a connection pipe configured to connect the inlet and the valve.

5. The automatic analyzer according to claim 1, wherein the guiding unit includes a tank configured to contain the cleaning fluid, and a connection pipe configured to connect the tank and the valve.

6. The automatic analyzer according to claim 1, wherein the guiding unit includes a connection pipe configured to connect an external container, which is configured to contain the cleaning fluid, and the valve.

7. The automatic analyzer according to claim 4, wherein a pump configured to send the cleaning fluid to the valve is disposed to the connection pipe.

8. The automatic analyzer according to claim 1, wherein a fluid surface detector is provided to the cleaning pool.

9. The automatic analyzer according to claim 8, wherein the fluid surface detector is a probe having a fluid surface detecting function.

10. The automatic analyzer according to claim 1, wherein the cleaning pool is configured to clean a probe of a reagent dispenser, a probe of a sample dispenser, or an agitator of an agitation mechanism.

11. The automatic analyzer according to claim 1,
wherein the cleaning pool includes a plurality of cleaning pools, and
wherein the guiding unit guides the cleaning fluid to the plurality of cleaning pools via the waste fluid pipe.

12. The automatic analyzer according to claim 11, wherein the waste fluid pipe connected to each of the plurality of cleaning pools communicates with the discharge port, which is a single discharge port.

13. The automatic analyzer according to claim 12, wherein the valve disposed to the waste fluid pipe includes a single valve.

14. A cleaning method for cleaning a cleaning pool and a waste fluid pipe of an automatic analyzer comprising:
the cleaning pool in which a predetermined member is cleaned with a fluid;
a discharge port from which the fluid is discharged;
the waste fluid pipe configured to connect the cleaning pool and the discharge port;
a valve disposed to the waste fluid pipe; and
a guiding unit configured to guide a cleaning fluid to the cleaning pool via the waste fluid pipe,
the method comprising:
closing a flow path between the cleaning pool and the discharge port by operating the valve;
guiding the cleaning fluid to the cleaning pool via the waste fluid pipe; and
discharging the cleaning fluid from the cleaning pool and the waste fluid pipe by operating the valve.

15. The cleaning method according to claim 14, further comprising:
detecting a fluid surface of the cleaning fluid in the cleaning pool after the guiding of the cleaning fluid.

16. The cleaning method according to claim 15, further comprising:
checking whether the valve is closed when it is not detected in the detecting of the fluid surface of the cleaning fluid that the fluid surface reaches a predetermined location.

17. The cleaning method according to claim 15, further comprising:
checking whether the valve is closed when, in the detecting of the fluid surface of the cleaning fluid, once it is detected that the fluid surface reaches a predetermined location, and then it is not detected that the fluid surface reaches the predetermined location.

18. The cleaning method according to claim 14, further comprising:
discharging the cleaning fluid from the cleaning pool and the waste fluid pipe by opening the valve when a predetermined time elapses after the guiding of the cleaning fluid is completed.
